(19) United States
(12) Patent Application Publication
(10) Pub. No.: US 2024/0313856 A1
(43) Pub. Date: Sep. 19, 2024

(54) DATA SECURITY IN LOW EARTH ORBIT DATA CENTERS

(71) Applicant: International Business Machines Corporation, Armonk, NY (US)

(72) Inventors: Gandhi Sivakumar, Bentleigh (AU); Kushal S. Patel, PUNE (IN); Sarvesh S. Patel, Pune (IN)

(21) Appl. No.: 18/183,996

(22) Filed: Mar. 15, 2023

(51) Int. Cl. H04B 7/185

(52) U.S. Cl. CPC H04B 7/18593; H04B 7/18586; H04B 7/18589

(57) ABSTRACT

Computer-implemented methods for securing data stored in a low earth orbit (LEO) data center are provided. Aspects include obtaining physical characteristics of a low earth orbit (LEO) data center and obtaining physical characteristics of one or more celestial objects. Aspects also include comparing the physical characteristics of the one or more celestial objects and the LEO data center. Based on a determination that the one or more celestial objects pose a risk to the LEO data center, aspects include backing up one or more data items stored on the LEO data center to another LEO data center in communication with the LEO data center.

### BACKGROUND

The present disclosure generally relates to low earth orbit data centers, and more specifically, to providing physical data security in low earth orbit data centers.

A low earth orbit (LEO) satellite is a satellite that is in an orbit that is relatively close to Earth's surface. The LEO satellite is normally at an altitude of less than 1,000 km and could be as low as 160 km above the surface of the Earth, which is low compared to other satellite orbits. Since the LEO satellites orbit the earth at a reasonability close distance, direct microwave transmission from the user devices to LEO satellites is possible. Accordingly, LEO satellites can be used as data centers to store data received from terrestrial based user devices.

### SUMMARY

Embodiments of the present disclosure are directed to computer-implemented methods for providing physical data security in a low earth orbit data center. According to an aspect, a computer-implemented method includes obtaining physical characteristics of a low earth orbit (LEO) data center and obtaining physical characteristics of one or more celestial objects. The method also includes comparing the physical characteristics of the one or more celestial objects and the LEO data center. Based on a determination that the one or more celestial objects pose a risk to the LEO data center, the method includes backing up one or more data items stored on the LEO data center to another LEO data center in communication with the LEO data center.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of components of a low earth orbit data center in accordance with one or more embodiments of the present disclosure;

FIGS. 3A, 3B, and 3C depict schematic illustrations of low earth orbit data centers in accordance with one or more embodiments of the present disclosure;

FIG. 4 is a flowchart of a method for securing data stored in a low earth orbit (LEO) data center in accordance with one or more embodiments of the present disclosure; and

FIG. 5 is a flowchart of a method for backing up one or more data items stored in the LEO data center to another LEO data center in accordance with one or more embodiments of the present disclosure.

### DETAILED DESCRIPTION

As discussed above, low Earth orbit (LEO) satellites can be used as data centers to store data received from terrestrial-based user devices. In general, the configuration of data centers on LEO satellites will need to consider the potential adverse effects of celestial events and apply the methods and system to the data center to ensure the safety and security of the data stored on the LEO data center. These celestial events can include both meteor showers and asteroids that pass close to the surface of the Earth. For example, it is possible that a meteor shower or asteroid could impact and destroy an LEO data center.

In exemplary embodiments, methods, systems, and computer program products are provided which secure data stored in a low earth orbit (LEO) data center against celestial events. In exemplary embodiments, the LEO data center is configured to determine the existence of an area of inference between detected celestial objects and the orbital path of the LEO data center. Based upon determining that an area of inference exists, the LEO data center performs data safeguarding by copying at least some of the data stored in the LEO data center to a new secure location on another LEO data center.

In exemplary embodiments, the LEO data center is configured to communicate with a celestial object detection service that is provided by the space station. In one embodiment, these connections are created via specialized application programming interface (API) integration to the space object detection processes in the space station. The LEO data center also obtains information about LEOs physical characteristics like orbit details, height from the surface of the Earth, trajectory vectors, speed, and acceleration due to gravity, etc., which are used to identify the area of inference. The trajectories of celestial objects are collected and mapped with the trajectory of the LEO data center and an area of inference is identified. The area of inference is located depending on the calculated minimum possible distance between the celestial objects and validated against the derived allowable limits. Based on a determination that the inference region is detected within the trajectory of the LEO data center, the celestial object poses a risk to the LEO data center and a data safeguarding procedure is triggered.

In exemplary embodiments, the LEO data center obtains information from the underlying storage engines about the presence of critical data and the amount of data that will need to be copied to a new location. In one embodiment, the LEO data center is part of an LEO data center network that includes multiple LEO data centers connected to each other via high-speed inter-satellite communication links. In this embodiment, the LEO transmits a query to the LEO data center network asking for the loaner space to save the critical data as a backup copy. Based on the response to the query, the LEO data center identifies a suitable backup location and transmits the data to the backup location. In exemplary embodiments, the identification of the suitable backup location is based on the available capacity of the backup location, the position of the backup location, and a type of celestial object that poses a risk to the LEO data center.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as data security in low Earth orbit data centers 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

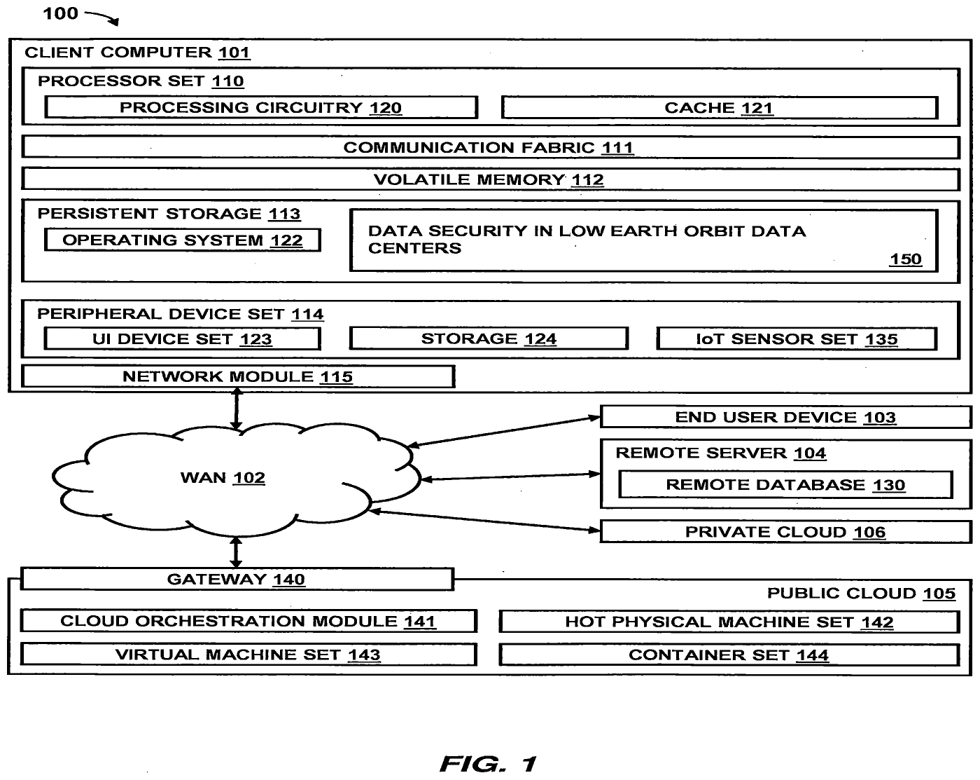

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

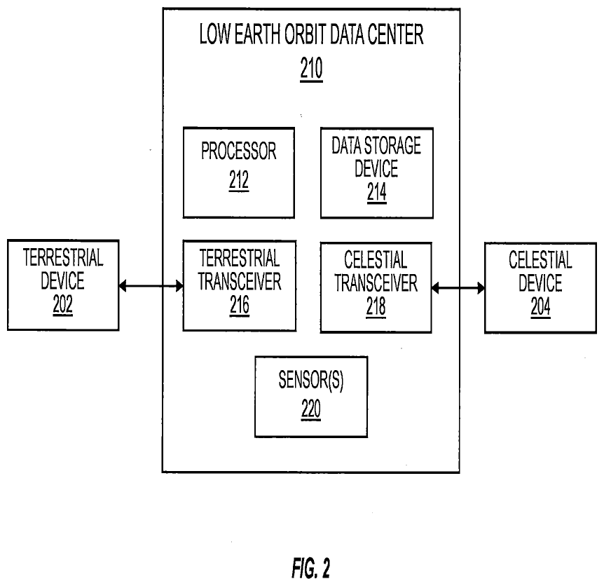

Referring now to FIG. 2 a block diagram of components of a low earth orbit data center 210 in accordance with one or more embodiments of the present disclosure is shown. In one embodiment, the low earth orbit (LEO) data center 210 may include a computer 100, such as the one shown in FIG. 1. In exemplary embodiments, an LEO data center 210 is a low Earth orbit satellite that includes a processor 212 and one or more data storage devices 214. The LEO data center 210 also includes a terrestrial transceiver 216 that is configured to send and receive data with one or more terrestrial devices 202. The LEO data center 210 further includes a celestial transceiver 218 that is configured to send and receive data with one or more celestial devices 204. In exemplary embodiments, the celestial devices 204 include other LEO data centers and a space station, such as the International Space Station.

The LEO data center 210 also includes one or more sensors 220 that are configured to determine one or more characteristics of the LEO data center 210, such as the speed of the LEO data center 210, the trajectory of the LEO data center 210, and the distance from the surface of the Earth of the LEO data center 210. In exemplary embodiments, the celestial transceiver 218 uses a high-powered microwave transmission to transmit data between the LEO data center 210 and other celestial devices 204. Due to the high-powered nature, e.g., in the range of twenty to sixty hertz, of the celestial transceiver 218, the celestial transceiver 218 is able to transmit data at significantly higher speeds than the terrestrial transceiver 216. For example, the terrestrial transceiver 216 is configured to transmit data to terrestrial devices 202 at approximately 200 MB/s while the celestial transceiver 218 is capable of transmitting data to other celestial devices 204 at approximately 5 GB/s.

In exemplary embodiments, the LEO data center 210 is configured to receive data from one or more terrestrial devices 202 and to store the data in one or more data storage devices 214. In addition, the LEO data center 210 is configured to obtain data regarding celestial objects that may come within a threshold range of the LEO data center 210. In exemplary embodiments, the processor 212 of the LEO data center 210 analyzes the data regarding identified celestial objects and data regarding the characteristics of the LEO data center 210 to determine whether there is a potential for the celestial objects to impact the operation of the LEO data center 210. Based on a determination that one or more of the celestial objects may impact the operation of the LEO data center 210, the LEO data center 210 is configured to backup at least some of the data stored in the data storage device 214 to another LEO data center 210 via the celestial transceiver 218.

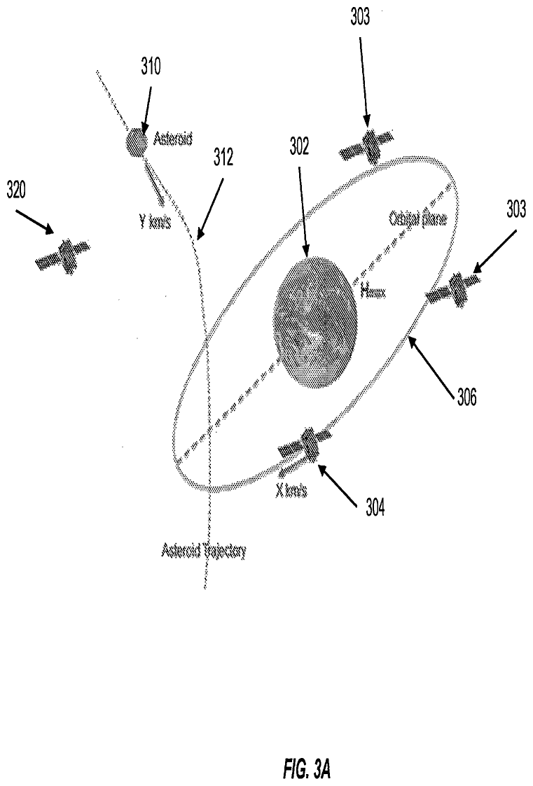

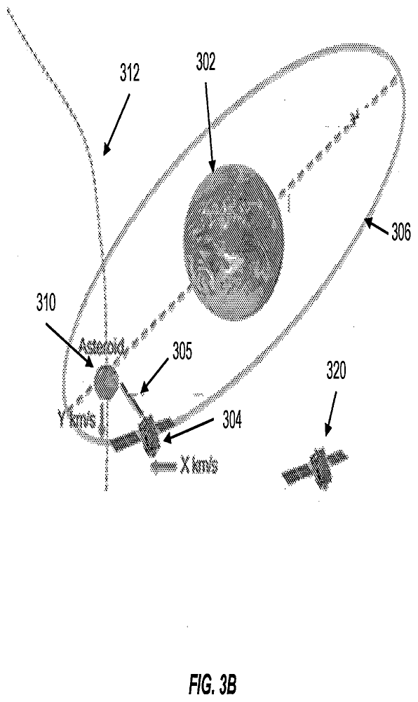

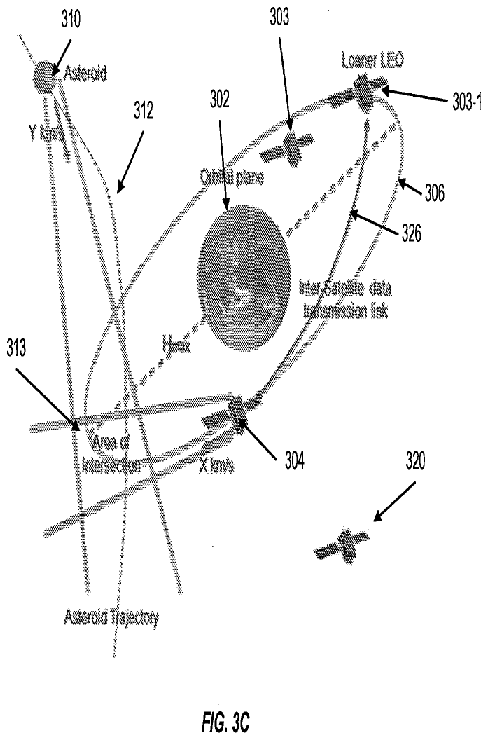

Referring now to FIGS. 3A, 3B, and 3C, schematic illustrations of LEO data centers 304 in accordance with one or more embodiments of the present disclosure are shown. As illustrated, an LEO data center 304, such as the one shown in FIG. 2, is in orbit 306 around the Earth 302. The LEO data center 304 is in communication with the space station 320, which is configured to track celestial objects that will come within a threshold range of the Earth 302. For example, the space station 320 will identify asteroid 310 and calculate a trajectory 312 of the asteroid 310. In exemplary embodiments, the LEO data center 304 is part of a LEO data center network that includes LEO data centers 303. In exemplary embodiments, one or more of the LEO data centers 303 in the network may have different orbital planes and be at different altitudes than the LEO data center 304.

As discussed above, the LEO data center 304 obtains physical characteristics of celestial objects, such as the asteroid 310, from the space station 320. The physical characteristics include the size, speed, and trajectory of the celestial objects. The LEO data center 304 compares the physical characteristics of the celestial objects with the physical characteristics of the LEO data center 304 to determine whether the celestial objects pose a risk to the LEO data center 304.

In one embodiment, as best shown in FIG. 3B, the determination that the celestial objects pose a risk to the LEO data center 304 is based on a determination that a minimum distance 305 that the celestial object will come within the LEO data center 304 is less than a threshold distance. In exemplary embodiments, the minimum distance 305 is set by an administrator of the LEO data center 304.

In another embodiment, as best shown in FIG. 3C, the determination that the celestial objects pose a risk to the LEO data center 304 is based on the identification of an interference area 313 that both the celestial object and the LEO data center 304 will be located within at the same time. In exemplary embodiments, the size of the interference area 313 is set by an administrator of the LEO data center 304.

In exemplary embodiments, once it is determined that the celestial objects pose a risk to the LEO data center 304, the LEO data center 304 transmits a copy of data stored on the LEO data center 304 to another LEO data center 303-1 via a transmission link 326. In exemplary embodiments, the another LEO data center 303-1 is identified from a network of LEO data centers 303 based on the available capacity of the LEO data center 303-1 and the location of the LEO data center 303-1.

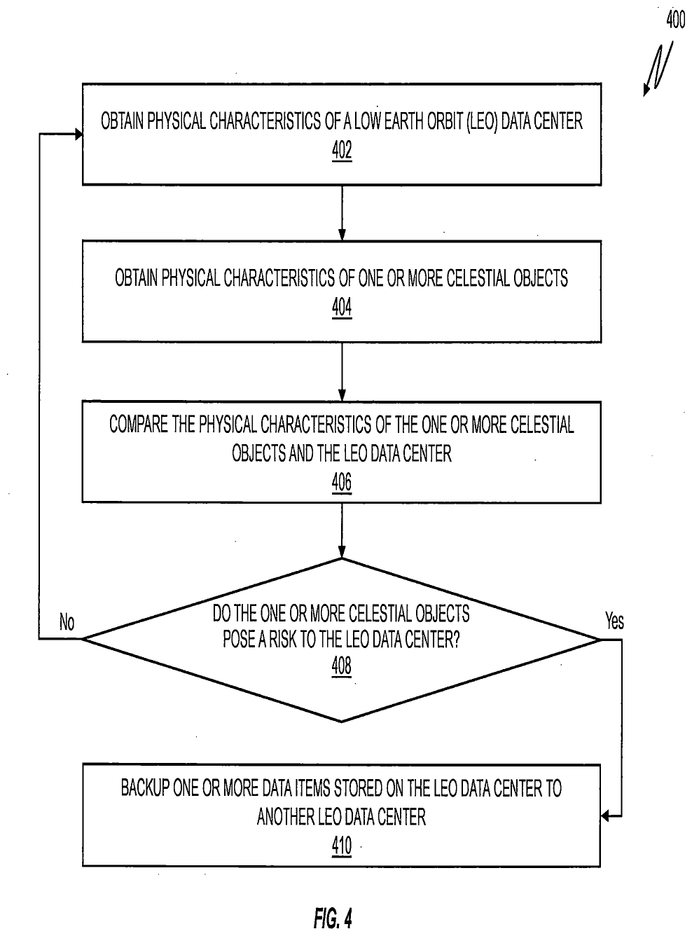

Referring now to FIG. 4, a flowchart of a method 400 for securing data stored in a low earth orbit (LEO) data center in accordance with one or more embodiments of the present disclosure is shown. In exemplary embodiments, the method 400 is performed by a controller of the LEO data center, such as the one shown in FIG. 2. The method 400 includes obtaining the physical characteristics of a low earth orbit (LEO) data center, as shown at block 402. In exemplary embodiments, the physical characteristics of a LEO data center include orbit details such as, distance from the surface of the Earth, trajectory vectors, speed, and acceleration due to gravity. Next, as shown at block 404, the method 400 includes obtaining the physical characteristics of one or more celestial objects. In exemplary embodiments, the physical characteristics of the one or more celestial objects include a size and a trajectory of the objects, which are obtained from a celestial object detection service of a space station. The method 400 also includes comparing the physical characteristics of the one or more celestial objects and the LEO data center, as shown at block 406.

The method 400 also includes determining whether the one or more celestial objects pose a risk to the LEO data center, as shown at decision block 408. In one embodiment, the determination of whether the one or more celestial objects pose a risk to the LEO data center includes determining if an interference area between the one or more celestial objects and the LEO data center. In anther embodiment, the determination of whether the one or more celestial objects pose a risk to the LEO data center includes determining if the one or more celestial objects will come within a minimum threshold distance of the LEO data center. Based on a determination that the one or more celestial objects pose a risk to the LEO data center, the method 400 proceeds to block 410 and includes backing up one or more data items stored on the LEO data center to another LEO data center.

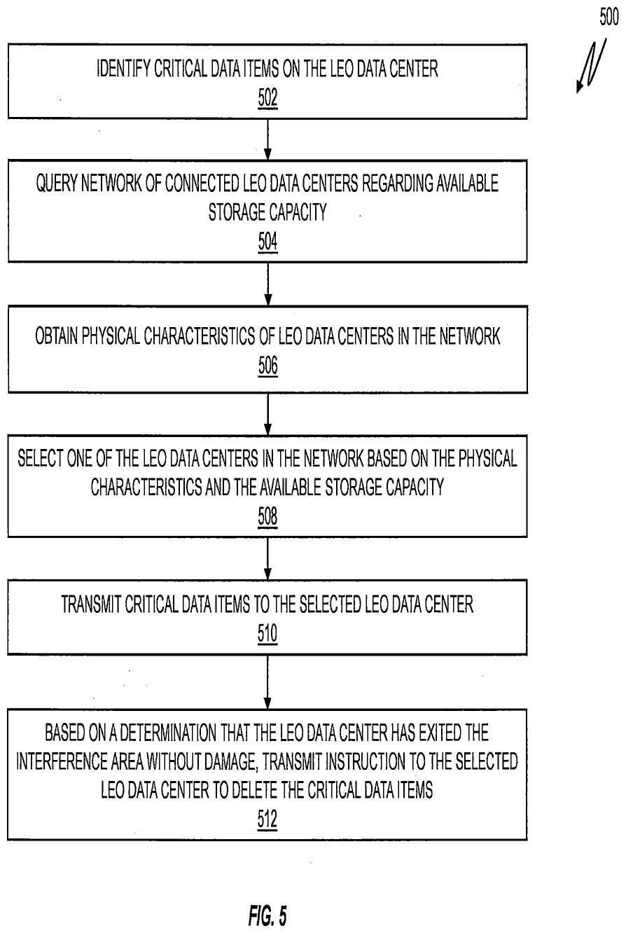

Referring now to FIG. 5, a flowchart of a method 500 for backing up one or more data items stored on the LEO data center to another LEO data center in accordance with one or more embodiments of the present disclosure is shown. In exemplary embodiments, the method 500 is performed by a controller of the LEO data center, such as the one shown in FIG. 2. The method 500 includes identifying one or more critical data items on the LEO data center. In one embodiment, the one or more critical data items are data items that are only stored on the LEO data center. In another embodiment, the LEO data items are data items that have been flagged as high-priority data items by an administrator of the LEO data center. The method 500 also includes querying a network of connected LEO data centers to obtain an available storage capacity of each of the LEO data centers, as shown at block 504. Next, as shown at block 506, the method 500 includes obtaining the physical characteristics of LEO data centers in the network.

The method 500 also includes selecting one of the LEO data centers in the network based on the physical characteristics and the available storage capacity, as shown at block 508. In exemplary embodiments, the selection is also based on a type of the one or more celestial objects. In one example, if an asteroid is detected in the inference region, then available LEO data centers will be selected that do not have an inference region with the asteroid. However, in the case of wider events like a meteor shower, the LEO selection is made depending on the distance and height of the LEO. Lower the height from the Earth is a better place since it has more atmosphere which can crash the meteors. Additionally, the angle from Earth should be kept at around one hundred and eighty degrees to the home location since the meteor belt can be passed quickly.

Next, as shown at block 510, the method 500 includes transmitting the critical data items to the selected LEO data center. The method 500 concludes at block 512 by transmitting an instruction to the selected LEO data center to delete the critical data items based on a determination that the LEO data center has exited the interference area without damage.

In exemplary embodiments, the LEO data center initiates an instance of a celestial object risk identifier algorithm. Upon initiation, the required data structures are created, defined data collection resources are triggered to, and receiver data locations are identified and provisioned. Next, a satellite infrastructure API is invoked to obtain the physical characteristics of the LEO data center, which includes the current height, orbital plane information and the average moving speed of the satellite data center. In exemplary embodiments, similar information is gathered from all the LEO data centers in the network and information is exchanged between the LEO data centers. In exemplary embodiments, the LEO data center is configured to communicate with a celestial object detection service from space station. The connection between the celestial object detection service and the LEO data center is created via specialized API integration to the space objects detection methods in the space stations.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for securing data stored in a low earth orbit (LEO) data center, comprising:
obtaining physical characteristics of a low earth orbit (LEO) data center;
obtaining physical characteristics of one or more celestial objects;
comparing the physical characteristics of the one or more celestial objects and the LEO data center;
based on a determination that the one or more celestial objects pose a risk to the LEO data center, backing up one or more data items stored on the LEO data center to another LEO data center in communication with the LEO data center.

2. The method of claim 1, wherein the physical characteristics of the LEO data center include orbit details of the LEO data center including a distance from an earth surface, a trajectory vector, and a speed of travel.

3. The method of claim 1, wherein the physical characteristics of the one or more celestial objects are obtained from a celestial object detection service of a space station.

4. The method of claim 1, wherein the determination that the one or more celestial objects pose the risk to the LEO data center is based on one of determining that an interference area exists between the one or more celestial objects and the LEO data center and determining that at least one of the one or more celestial objects will come within a threshold distance of the LEO data center.

5. The method of claim 4, wherein the threshold distance is a distance that is set by an administrator of the LEO data center.

6. The method of claim 1, wherein backing up the one or more data items stored on the LEO data center to another LEO data center in communication with the LEO data center comprises:
querying a network of connected LEO data centers, including the another LEO data center, to obtain an available storage capacity for each of the network of connected LEO data centers;
obtaining physical characteristics of each of the network of connected LEO data centers; and
selecting the another data center from the network of connected LEO based on the available storage capacity and the physical characteristics of each of the network of connected LEO data centers.

7. The method of claim 1, further comprising transmitting an instruction to the selected LEO data center to delete the one or more data items based on a determination that the LEO data center has exited the interference area without damage.

8. A computing system having a memory having computer readable instructions and one or more processors for executing the computer readable instructions, the computer readable instructions controlling the one or more processors to perform operations comprising:
obtaining physical characteristics of a low earth orbit (LEO) data center;
obtaining physical characteristics of one or more celestial objects;
comparing the physical characteristics of the one or more celestial objects and the LEO data center;
based on a determination that the one or more celestial objects pose a risk to the LEO data center, backing up one or more data items stored on the LEO data center to another LEO data center in communication with the LEO data center.

9. The computing system of claim 8, wherein the physical characteristics of the LEO data center include orbit details of the LEO data center including a distance from an earth surface, a trajectory vector, and a speed of travel.

10. The computing system of claim 8, wherein the physical characteristics of the one or more celestial objects are obtained from a celestial object detection service of a space station.

11. The computing system of claim 8, wherein the determination that the one or more celestial objects pose the risk to the LEO data center is based on one of determining that an interference area exists between the one or more celestial objects and the LEO data center and determining that at least one of the one or more celestial objects will come within a threshold distance of the LEO data center.

12. The computing system of claim 11, wherein the threshold distance is a distance that is set by an administrator of the LEO data center.

13. The computing system of claim 8, wherein backing up the one or more data items stored on the LEO data center to another LEO data center in communication with the LEO data center comprises:
querying a network of connected LEO data centers, including the another LEO data center, to obtain an available storage capacity for each of the network of connected LEO data centers;
obtaining physical characteristics of each of the network of connected LEO data centers; and
selecting the another data center from the network of connected LEO based on the available storage capacity and the physical characteristics of each of the network of connected LEO data centers.

14. The computing system of claim 8, wherein the operations further comprise transmitting an instruction to the selected LEO data center to delete the one or more data items based on a determination that the LEO data center has exited the interference area without damage.

15. A computer program product comprising a computer readable storage medium having program instructions embodied therewith, the program instructions executable by a processor to cause the processor to perform operations comprising:
obtaining physical characteristics of a low earth orbit (LEO) data center;
obtaining physical characteristics of one or more celestial objects;
comparing the physical characteristics of the one or more celestial objects and the LEO data center;
based on a determination that the one or more celestial objects pose a risk to the LEO data center, backing up one or more data items stored on the LEO data center to another LEO data center in communication with the LEO data center.

16. The computer program product of claim 15, wherein the physical characteristics of the LEO data center include orbit details of the LEO data center including a distance from an earth surface, a trajectory vector, and a speed of travel.

17. The computer program product of claim 15, wherein the physical characteristics of the one or more celestial objects are obtained from a celestial object detection service of a space station.

18. The computer program product of claim 15, wherein the determination that the one or more celestial objects pose the risk to the LEO data center is based on one of determining that an interference area exists between the one or more celestial objects and the LEO data center and determining that at least one of the one or more celestial objects will come within a threshold distance of the LEO data center.

19. The computer program product of claim 18, wherein the threshold distance is a distance that is set by an administrator of the LEO data center.

20. The computer program product of claim 15, wherein backing up the one or more data items stored on the LEO data center to another LEO data center in communication with the LEO data center comprises:
querying a network of connected LEO data centers, including the another LEO data center, to obtain an available storage capacity for each of the network of connected LEO data centers;
obtaining physical characteristics of each of the network of connected LEO data centers; and
selecting the another data center from the network of connected LEO based on the available storage capacity and the physical characteristics of each of the network of connected LEO data centers.
